(19) United States
(12) Patent Application Publication
(10) Pub. No.: US 2011/0017570 A1
(43) Pub. Date: Jan. 27, 2011

(54) ROTATING BAG FEEDING DEVICE AND METHOD FOR A PALLETIZING SYSTEM

(75) Inventor: MICHAEL GRAF, SPRINGFIELD, IL (US)

Correspondence Address: THE SMALL PATENT LAW GROUP LLP, 225 S. MERAMEC, STE. 725T, ST. LOUIS, MO, 63105, US

(73) Assignee: PRODUCTIVE AUTOMATED SYSTEMS CORP., SAINT LOUIS, MO (US)

(21) Appl. No.: 12/508,318

(22) Filed: Jul. 23, 2009

(51) Int. Cl. B65G 47/24

(52) U.S. Cl. 198/374

(57) ABSTRACT

A bag feeding device for a palletizing system includes a conveyor, bag turning assemblies, and a rotation device. The conveyor moves bags to a staging area. Each of the bags extends between opposite ends along a longitudinal axis. The bag turning assemblies are configured to individually move toward and away from the conveyor independent of one another to engage and avoid engagement, respectively, with the bags as the bags move toward the palletizing staging area. The rotation device is operatively coupled to the bag turning assembles and is configured to rotate the bag turning assemblies and the bags engaged by the bag turning assemblies about a rotational axis. The bag turning assemblies avoid engagement with at least one of the bags in a first set and engage and rotate at least one of the bags in a second set to arrange the bags in first and second rows, respectively, in the palletizing staging area.

### BACKGROUND OF THE INVENTION

The subject matter herein relates generally to palletizing systems.

Known palletizing systems arrange bags for placement of the bags onto a pallet or other storage unit. The systems include conveyors and other components that move the bags and, as the bags move along the conveyors rotate or otherwise re-orient the bags. The bags are received onto the pallet in a predetermined pattern that is created by the movement and re-orientation of the bags.

Some known systems arrange the bags by conveying the bags in a linear direction and rotating at least some of the bags. These systems include a post or other immobile located downstream of the bags along a conveyor. The post is located off center of the bags. The bags move along the conveyor in a downstream direction and eventually contact the post. The bags individually contact the post at or proximate to one of the corners of the bags. The conveyor continues to move the bags in the downstream direction. The engagement between the bag and the post combined with the continued movement of the conveyor in the downstream direction may cause the bag to rotate about the post. The rotated bag then continues to travel along the downstream direction by the conveyor. Some other known systems include an arm that flips out from a side of the conveyor to rotate bags as the bags are conveyed by the conveyor. For example, the arm may flip out from a side wall of the conveyor as a bag passes the arm. The arm may partially rotate the bag with respect to the side wall. The rotated bag continues along the conveyor in the downstream direction. Other known systems include a turning device that lowers towards the conveyor as the bags pass below the turning device. The turning device contacts a bag and spins the bag on the conveyor. The bag is spun such that the bag is rotated but continues to travel along the same path or direction along the conveyor.

The known palletizing systems are limited in the speed at which the bags are arranged by the systems. For example, some known palletizing systems that rotate at least some of the bags are limited to arranging 42 to 45 bags per minute. Increasing this speed may result in increased throughput of the systems. Additionally, the density in which the bags are arranged by the systems may be relatively low. For example, the systems may convey rotated bags and non-rotated bags along the same path and stack the rotated and non-rotated bags on top of one another. Such a packing of the bags suffers from a significant amount of wasted volume.

A need thus exists for a palletizing system that increases the speed at which bags and other objects are arranged by the system. Additionally, a need exists for a palletizing system that increases the spatial density in which the bags are packed.

### BRIEF DESCRIPTION OF THE INVENTION

In one embodiment, a bag feeding device for a palletizing system is provided. The bag feeding device includes a conveyor, a plurality of bag turning assemblies, and a rotation device. The conveyor moves bags to a palletizing staging area. Each of the bags extends between opposite ends along a longitudinal axis. The bag turning assemblies are disposed above the conveyor and are configured to individually move toward and away from the conveyor independent of one another to engage and avoid engagement, respectively, with the bags as the bags move toward the palletizing staging area. The rotation device is operatively coupled to the bag turning assembles and is configured to rotate the bag turning assemblies and the bags engaged by the bag turning assemblies about a rotational axis. The bag turning assemblies avoid engagement with at least one of the bags in a first set and engage and rotate at least one of the bags in a second set to arrange the bags in first and second rows, respectively, in the palletizing staging area.

In another embodiment, another bag feeding device for a palletizing system is provided. The device includes a conveyor, a bag turning assembly and a rotating device. The conveyor moves bags along a feed direction toward a palletizing staging area. Each of the bags extends between opposite ends along a longitudinal axis. The bag turning assembly is configured to move toward and away from the conveyor to engage and avoid engagement, respectively, with the bags as the bags move toward the palletizing staging area. The bag turning assembly is configured to rotate the bags engaged by the bag turning assembly. The rotating device is operatively coupled with the bag turning assembly and is configured to rotate the bag turning assembly about a rotation axis. The bag turning assembly switches between avoiding engagement with the bags and engaging and rotating the bags as the bags move toward the palletizing staging area to arrange the bags in first and second rows in individual layers of bags, the longitudinal axis of the bag in the first row being angled with respect to the longitudinal axes of the bags in the second row.

In one embodiment, a method for arranging bags travelling along a conveyor in a feed direction toward a palletizing staging area is provided. The method includes providing a bag turning assembly that is configured to be raised and lowered toward the conveyor, with the bag turning assembly rising away from the conveyor to avoid blocking movement of the bags in the feed direction and lowering toward the conveyor to block movement of the bags in the feed direction. The method also includes providing a rotating device that is operatively coupled with the bag turning assembly and configured to rotate the bag turning assembly about a rotation axis. The bag turning assembly and the rotating device are configured to raise the bag turning assembly and lower and rotate the bag turning assembly in a predefined sequence to arrange the bags in first and second rows in the palletizing staging area.

### BRIEF DESCRIPTION OF THE DRAWINGS

FIG. 1 is a perspective view of a bag feeding device for a palletizing system in accordance with one embodiment.

FIG. 2 is a perspective view of a rotation device, bag turning assemblies and frame shown in FIG. 1 in accordance with one embodiment.

FIG. 3 illustrates another perspective view of the bag feeding device in accordance with one embodiment.

FIG. 4 illustrates another perspective view of the bag feeding device in accordance with one embodiment.

FIG. 5 illustrates another perspective view of the bag feeding device in accordance with one embodiment.

FIG. 6 illustrates another perspective view of the bag feeding device in accordance with one embodiment.

FIG. 7 is an overhead view of the bag feeding device in accordance with one embodiment.

### DETAILED DESCRIPTION OF THE INVENTION

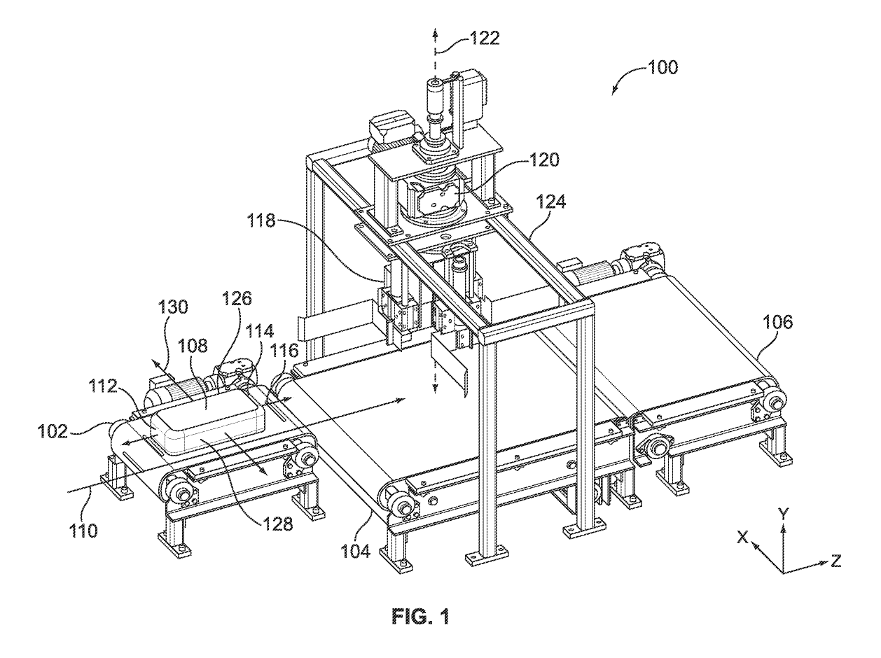

FIG. 1 is a perspective view of a bag feeding device 100 for a palletizing system in accordance with one embodiment. The bag feeding device 100 includes several conveyors 102-106 that generally move bags 108 along a feed direction 110. The bags 108 contain any of a variety of goods or materials. By way of example only, the bags 108 may contain ice, grain, building materials (such as concrete), other granular materials, and the like. The bags 108 in the illustrated embodiment are elongated between opposite ends 112, 114 along a longitudinal axis 116. The bags 108 extend between opposite sides 126, 128 along a lateral axis 130. The longitudinal and lateral axes 116, 130 may be transverse to one another. Alternatively, the bags 108 have a different shape. For example, the bags 108 may not be elongated along the longitudinal axis 116.

The conveyors 102-106 include a pacing conveyor 102 that supplies the bags 108 to a turner conveyor 104. The pacing conveyor 102 may provide the bags 108 to the turner conveyor 104 at a predetermined rate or frequency. For example, the pacing conveyor 102 may move the bags 108 toward the turning conveyor 104 at a predetermined speed while the bags 108 are placed onto the pacing conveyor 102 at a predetermined rate. The pacing conveyor 102 delivers the bags 108 to the turning conveyor 104 such that the bags 108 are received at the turning conveyor 104 on an approximately regular and periodic basis. Additionally, the bags 108 may be received at the turning conveyor 104 such that consecutive bags 108 are separated from one another by an approximately constant distance.

The turner conveyor 104 receives the bags 108 from the pacing conveyor 102 and propels the bags 108 along the feed direction 110. The turner conveyor 104 conveys the bags 108 toward a pick conveyor 106. As shown in FIG. 1, the pacing conveyor 102 and pick conveyor 106 are disposed on opposite ends of the turner conveyor 104 and the turner conveyor 104 linearly moves the bags 108 along the feed direction 110 from the pacing conveyor 102 to the pick conveyor 106. Alternatively, the turner conveyor 104 may move the bags 108 along a non-linear path or direction. For example, the turner conveyor 104 may include one or more bends, undulations, or other features that cause the bags 108 to be conveyed in a non-linear direction or along a non-linear path from the pacing conveyor 102 to the pick conveyor 106.

As the bags 108 travel along the feed direction 110, one or more bag turning assemblies 118 raise and lower relative to the turner conveyor 104 between raised and lowered positions. The bag turning assemblies 118 may individually move up and down relative to the turner conveyor 104. For example, one bag turning assembly 118 may rise and/or lower toward the turner conveyor 104 independent of one or more other bag turning assemblies 118. In the illustrated embodiment, the bag feeding device 100 includes four bag turning assemblies 118. The bag turning assemblies 118 are circumferentially displaced from one another by approximately ninety degrees. Alternatively, a different number of bag turning assemblies 118 may be provided and/or the bag turning assemblies 118 may be separated by a different distance.

The bag turning assemblies 118 rise away from the turner conveyor 104 to move the bag turning assemblies 118 out of the direction of travel of the bags 108. Moving a bag turning assembly 118 located above or in the direction of travel of a bag 108 causes the bag 108 to avoid contact with the bag turning assembly 118 as the bag 108 moves toward the pick conveyor 106. By avoiding contact or engagement with the bag turning assembly 118, the bag 108 continues to move toward the pick conveyor 106 with the longitudinal axis 116 of the bag 108 being oriented along the feed direction 110. The bag turning assemblies 118 lower toward the turner conveyor 104 to position the bag turning assemblies 118 into the direction of travel of the bags 108. Moving a bag turning assembly 118 located above or in the direction of travel of a bag 108 causes the bag turning assembly 118 to engage the bag 108 and block the bag 108 from continuing to move along the feed direction 110 toward the pick conveyor 106.

A rotation device 120 is operatively coupled with the bag turning assemblies 118. For example, the bag turning assemblies 118 may be directly or indirectly mounted or coupled to the rotation device 120. The rotation device 120 rotates the bag turning assemblies 118 about or around a rotation axis 122. In the illustrated embodiment, the rotation axis 122 is oriented transverse to the feed direction 110. For example, the rotation axis 122 is shown as being perpendicular with respect to the feed direction 110 and the top surface of the turner conveyor 104. The rotation device 120 rotates the bag turning assemblies 118 to also rotate a bag 108 that has been blocked by a bag turning assembly 118. For example, after one of the bag turning assemblies 118 is lowered to block movement of a bag 108, the rotation device 120 rotates the bag turning assembly 118 about the rotation axis 122 to also rotate the bag 108. In one embodiment, the rotation device 120 and bag turning assembly 118 rotate the bag 108 by approximately ninety degrees such that the longitudinal axis 116 of the bag 108 is approximately transverse to the feed direction 110. Alternatively, the bag 108 is rotated a different amount. For example, the bag 108 may be rotated by the rotation device 120 and bag turning assembly 118 by less than ninety degrees.

A frame 124 supports the rotation device 120 and bag turning assemblies 118 above the turner conveyor 104. As shown in FIG. 1, the frame 124 rises from the floor or surface on opposite sides of the turner conveyor 104 and over the turner conveyor 104. Alternatively, the frame 124 may extend downward from the ceiling or other structure located above the turner conveyor 104.

The bag 108 is disengaged or released by the bag turning assembly 118 after the bag 108 is rotated by the rotation device 120. After the bag 108 is released, the rotated bag 108 is conveyed by the turner conveyor 104 toward the pick conveyor 106. The rotated bag 108 is received at the pick conveyor 106 in an angled orientation with respect to the bags 108 that are not rotated by the bag turning assemblies 118. Permitting some of the bags 108 to pass underneath the bag turning assemblies 118 without being rotated while rotating other bags 108 as the bags 108 travel toward the pick conveyor 106 permits the bag feeding device 100 to arrange the bags 108 in a predetermined arrangement or pattern at the pick conveyor 106. The bags 108 are removed from the pick conveyor 106. In one embodiment, a robotic arm (not shown) may grab and lift the bags 108 from the pick conveyor 106 and move the bags 108 while keeping the bags 108 in the predetermined arrangement or pattern. Alternatively, the pick conveyor 106 may move the bags 108 along the feed direction 110 to another location, such as a pallet (not shown). The robotic arm or pick conveyor 106 may move the bags 108 onto a pallet, for example.

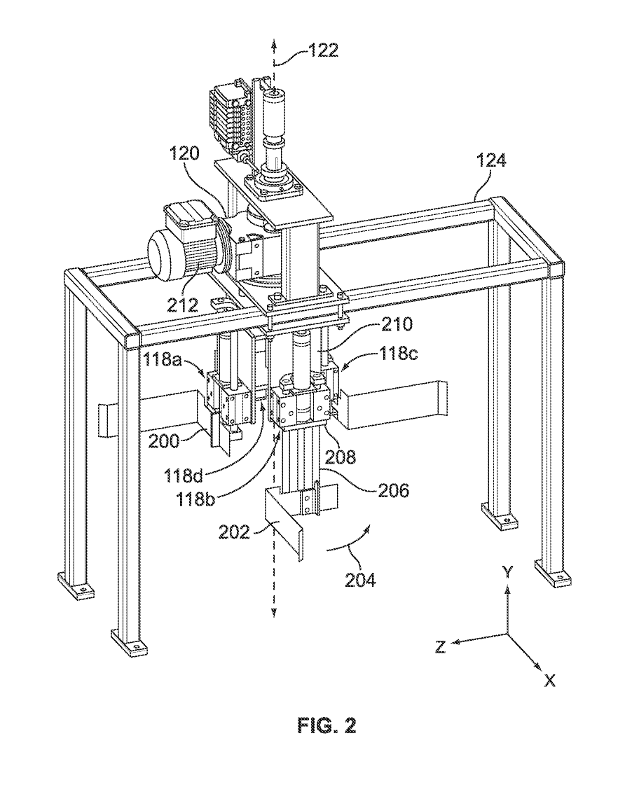

FIG. 2 is a perspective view of the rotation device 120, bag turning assemblies 118 and frame 124 in accordance with one embodiment. The bag turning assemblies 118 are labeled 118A through 118D in FIG. 2, but the bag turning assemblies 118A-D may be substantially identical to one another. Each of the bag turning assemblies 118A-D includes a blocking paddle 200 and a rotating paddle 202. The blocking and rotating paddles 200, 202 are substantially planar bodies that are angled with respect to one another in the illustrated embodiment. For example, the blocking paddle 200 and rotating paddle 202 may be approximately perpendicular to one another. Alternatively, the blocking and rotating paddles 200, 202 are disposed at another angle with respect to one another.

As described herein, the blocking and rotating paddles 200, 202 are lowered toward the turner conveyor 104 (shown in FIG. 1) to stop motion of a bag 108 (shown in FIG. 1) along the feed direction 110 (shown in FIG. 1). The blocking paddle 200 engages and blocks the bag 108 from continuing to linearly move along the feed direction 110. The bag turning assembly 118A-D is then rotated by the rotation device 120. As the bag turning assembly 118A-D that is in contact with the bag 108 rotates, the rotating paddle 202 pushes the bag 108 along an arc 204. The rotating paddle 202 rotates the bag 108 along the arc 204 defined by the rotation of the bag turning assembly 118A-D. The rotating paddle 202 continues to move the bag 108 along the arc 204 until the blocking paddle 200 is no longer positioned to block movement of the bag 108 by the turner conveyor 104. Once the blocking paddle 200 is rotated out of the way of the bag 108, movement of the turner conveyor 104 resumes conveying the bag 108 in the feed direction 110.

The blocking and rotating paddles 200, 202 are coupled to several extension members 206. In the illustrated embodiment, the extension members 206 are cylindrical bodies such as tubes or pipes. The extension members 206 are fixed to the blocking paddle 200. Alternatively, one or more of the extension members 206 may be coupled with the rotating paddle 202. A different number of extension members 206 may be provided in each bag turning assembly 118A-D than the number of extension members 206 shown in FIG. 2.

The extension, members 206 of each bag turning assembly 118 interconnect the blocking and rotating paddles 200, 202 with a lifting actuator 208. The lifting actuator 208 may be a pneumatically driven actuator that raises and lowers the extension members 206. Alternatively, the lifting actuator 208 may be a motor that raises and lowers the extension members 206. The lifting actuators 208 raise the corresponding extension members 206 upward toward the rotation device 120 and away from the turner conveyor 104 (shown in FIG. 1). The lifting actuators 208 also lower the extension members 206 downward away from the rotation device 120 and toward the turner conveyor 104. The lifting actuators 208 raise and lower the extension members 206 in order to also raise and lower the blocking and rotating paddles 200, 202. In one embodiment, the lifting actuator 208 raises the blocking and rotating paddles 200, 202 to an upper position and lowers the blocking and rotating paddles 200, 202 to a lower position. As shown in FIG. 2, the blocking and rotating paddles 200, 202 of the bag turning assemblies 118A, 118C and 118D are shown in the upper position with the extension members 206 raised up and through the lifting device 206. The blocking and rotating paddles 200, 202 of the bag turning assembly 118B is shown in the lowered position. Alternatively, the lifting actuator 208 may raise and/or lower the blocking and rotating paddles 200, 202 to one or more positions between the upper and lower positions.

The lifting actuator 208 of each bag turning assembly 118 raises the blocking and rotating paddles 200, 202 of a bag turning assembly 118 in order to avoid blocking movement of a bag 108 (shown in FIG. 1) along the feed direction 110 (shown in FIG. 1) by the turner conveyor 104. The lifting actuator 208 lowers the blocking and rotating paddles 200, 202 of the bag turning assembly 118 to block movement of a bag 108 along the feed direction 110 with the blocking paddle 200 and to enable the rotating paddle 202 to rotate the bag 108. The lifting actuators 208 may be independently driven to raise and lower each corresponding bag turning assembly 118 independent of the other bag turning assemblies 118. For example, the lifting actuators 208 may raise the bag turning assemblies 118A-C while lowering the bag turning assembly 118D. In one embodiment, one or more of the bag turning assemblies 118A-D may be raised or lowered without impacting or affecting the position or location of any other bag turning assembly 118A-D.

The lifting actuators 208 are operatively coupled to the rotation device 120. For example, the lifting actuators 208 may be fixed to plates 210 that are joined with the rotation device 120. The rotation device 120 is device that rotates the bag turning assemblies 118 about the rotation axis 122. For example, the rotation device 120 may include a motor 212 that rotates the plates 210 around the rotation axis 122. In one embodiment, the motor 212 of the rotation device 120 also drives the lifting actuators 208 to raise and lower the bag turning assemblies 118 between the upper and lower positions. The rotation device 120 rotates the bag turning assemblies 118 in order to position one of the bag turning assemblies 118 in the path of travel of a bag 108 (shown in FIG. 1) along the turner conveyor 104 (shown in FIG. 1). For example, the rotation device 120 may rotate the bag turning assemblies 118A-D until the bag turning assembly 118A is aligned with the path of travel of a bag 108 in the feed direction 110 (shown in FIG. 1). The bag turning assembly 118A is aligned with the path of travel when the blocking paddle 200 of the bag turning assembly 118A is positioned to block movement of the bag 108. For example, the bag turning assembly 118A may be aligned with the path of travel of the bag 108 when the blocking paddle 200 is angled with respect to the feed direction 110 and/or the path of travel of the bag 108.

The rotation device 120 may rotate the bag turning assemblies 118A-D in a stop-and-go manner instead of continually rotating the bag turning assemblies 118A-D. For example, the rotation device 120 may rotate the bag turning assemblies 118A-D until the bag turning assembly 118A is aligned with the path of travel of a bag 108 (shown in FIG. 1). The rotation device 120 then stops rotation of the bag turning assemblies 118A-D until the blocking and rotating paddles 200, 202 of the bag turning assembly 118A are lowered to engage the bag 108. The rotation device 120 then rotates the bag turning assemblies 118A-D until the bag turning assembly 118A rotates and releases the bag 108 and another bag turning assembly 118D is aligned with the path of travel of the next bag 108. For example, the rotation device 120 may simultaneously rotate one bag turning assembly 118A to rotate a bag 108 while rotating another bag turning assembly 118D into a position where the bag turning assembly 118D is aligned with the path of travel of a subsequent bag 108.

Once the bag turning assembly 118A is aligned with the path of travel of the bag 108, the lifting actuator 208 of the bag turning assembly 118A lowers the blocking paddle 200 toward the turner conveyor 104 (shown in FIG. 1). The blocking paddle 200 then blocks motion of the bag 108. The rotation device 120 rotates the bag turning assemblies 118A-D to rotate the bag 108 that is in contact with the blocking and/or rotating paddles 200, 202 of the bag turning assembly 118A. The rotation device 120 continues to rotate the bag turning assemblies 118A-D until the blocking and rotating paddles 200, 202 of the bag turning assembly 118A release the rotated bag 108 to permit the bag 108 to continue travelling along the feed direction 110 (shown in FIG. 1).

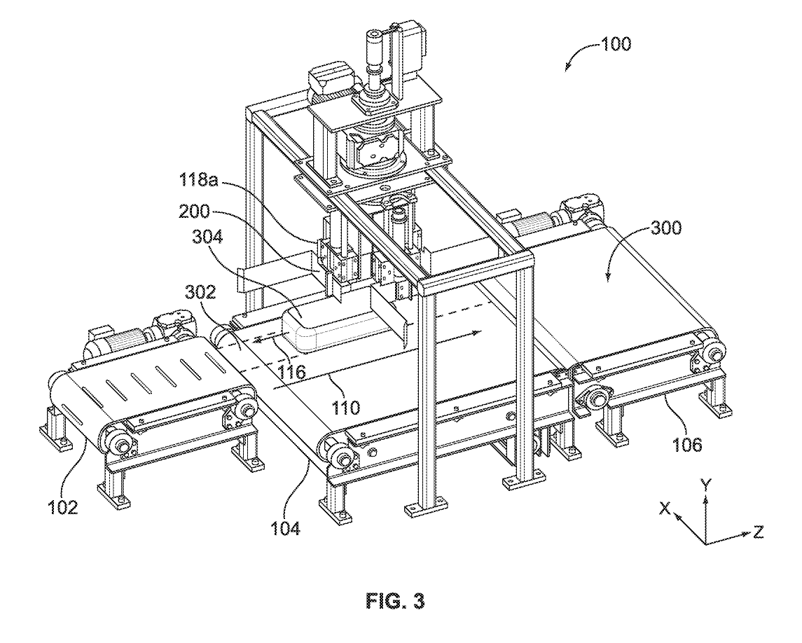

FIGS. 3 through 6 illustrate perspective views of the bag feeding device 100 in accordance with one embodiment. The views shown in FIGS. 3 through 6 demonstrate operation of the bag feeding device 100 as a series of bags 304, 400 are conveyed along the feed direction 110 to a palletizing staging area 300 at the pick conveyor 106. A first bag 304 is fed to the turner conveyor 104 by the pacing conveyor 102. The first bag 304 moves along an initial path 302 across the turner conveyor 104. The initial path 302 is a route along which the first bag 108 is conveyed from the pacing conveyor 102 to the pick conveyor 106. In the illustrated embodiment, the initial path 302 is a linear route across the turner conveyor 104.

As shown in FIG. 3, the bag turning assembly 118A is in the upper position. The bag turning assembly 118A is raised to the upper position to avoid engagement or contact between the blocking paddle 200 of the bag turning assembly 118A and the first bag 304. As a result, the turner conveyor 104 moves the first bag 304 in the feed direction 110 along the initial path 302 without the first bag 304 being blocked, moved or otherwise engaged by the bag turning assembly 118A. The first bag 304 moves along the initial path 302 to the palletizing staging area 300. As the first bag 304 is not rotated by the bag turning assembly 118A, the first bag 304 arrives at the palletizing staging area 300 with the longitudinal axis 116 of the first bag 304 being approximately parallel to the feed direction 110. For example, the first bag 304 is conveyed from the pacing conveyor 102 to the pick conveyor 106 without the orientation of the longitudinal axis 116 of the first bag 304 being changed.

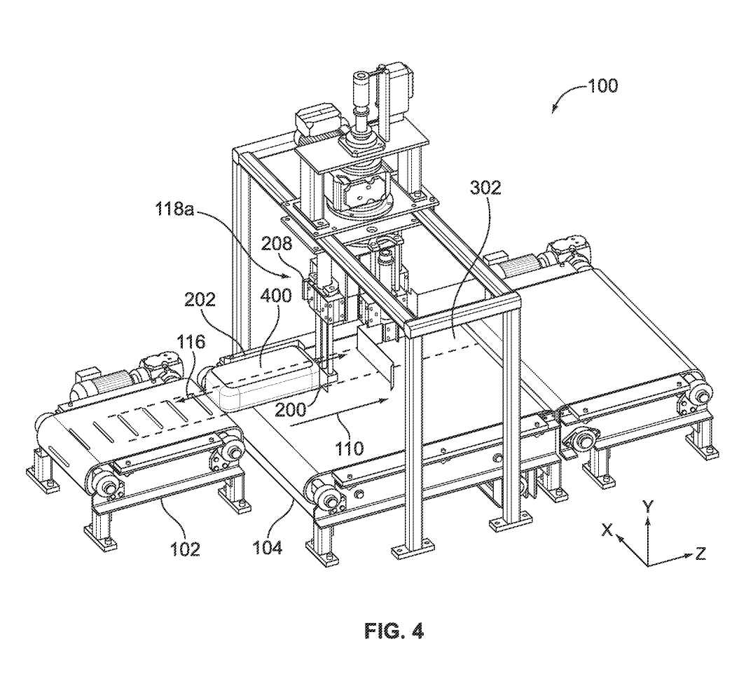

The movement and rotation of a second bag 400 is shown in FIGS. 4 through 6. The second bag 400 may be a subsequent bag to the first bag 304 in the series of bags 108 (shown in FIG. 1) that are fed to the turner conveyor 104 by the pacing conveyor 102. Similar to the first bag 304 (shown in FIG. 3), the second bag 400 moves from the pacing conveyor 102 to the turner conveyor 104 in the feed direction 110 along the initial path 302. The longitudinal axis 116 of the second bag 400 initially is oriented along the feed direction 110. For example, prior to engaging any of the bag turning assemblies 118, the longitudinal axis 116 of the second bag 400 is approximately parallel to the feed direction 110.

The lifting actuator 208 of the bag turning assembly 118A lowers the blocking and rotating paddles 200, 202 of the bag turning assembly 118A toward the turner conveyor 104 as the second bag 400 moves along the initial path 302. The lifting actuator 208 lowers the blocking paddle 200 until the blocking paddle 200 is positioned to stop movement of the second bag 400 in the feed direction 110 along the initial path 302. The second bag 400 moves toward and engages the blocking paddle 200. The blocking paddle 200 blocks movement of the second bag 400 and prevents the second bag 400 from continuing to move along the initial path 302.

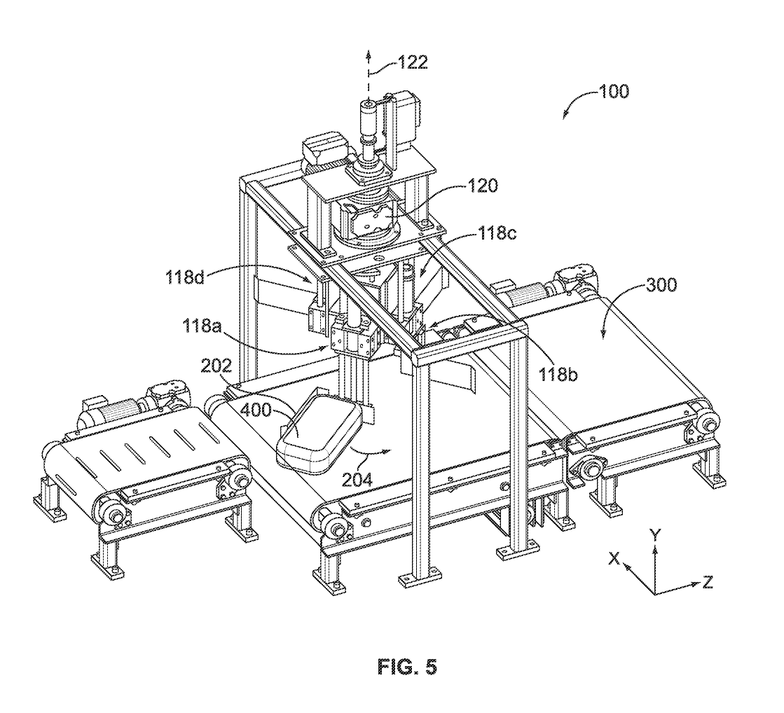

As shown in FIG. 5, the rotation device 120 rotates the bag turning assembly 118A along the arc 204 toward the palletizing staging area 300. The rotation device 120 rotates the bag turning assembly 118A about the rotation axis 122 while the bag turning assembly 118A is in the lowered position shown in FIGS. 4 through 6. As the bag turning assembly 118A rotates, the rotating paddle 202 of the bag turning assembly 118A engages the second bag 400. The rotating paddle 202 contacts and rotates the second bag 400 along the arc 204 as the bag turning assembly 118A is rotated along the arc 204. As shown in FIG. 5, the other bag turning assemblies 118B-D may be simultaneously rotated about the rotation axis 122 as the bag turning assembly 118A is rotated. The simultaneous rotation of the bag turning assemblies 118A-D provides for the concurrent rotation of the second bag 400 using the bag turning assembly 118A and the alignment of the bag turning assembly 118D for the next bag 108 (shown in FIG. 1). For example, the bag turning assembly 118D may be rotated into the same or similar position of the bag turning assembly 118A that is shown in FIG. 3 as the bag turning assembly 118A rotates the second bag 400. The concurrent rotation of the bag turning assembly 118A and the alignment of the bag turning assembly 118D for a subsequent bag 108 can increase the speed at which the bags 108 are received at the pick conveyor 106. For example, the bags 108 may be fed to the turner conveyor 104 and arranged in the pick conveyor 106 at a rate of at least approximately 45 to 50 bags per minute.

The rotation device 120 continues to rotate the bag turning assembly 118A until the bag turning assembly 118A releases the second bag 400. The bag turning assembly 118A releases the second bag 400 when the bag turning assembly 118A permits the second bag 400 to resume movement along the feed direction 110 on the turner conveyor 104. For example, the bag turning assembly 118A may release the second bag 400 when neither the blocking paddle 200 nor the rotating paddle 202 block, prevent or otherwise impede movement of the second bag 400 along the turner conveyor 104 in the feed direction 110.

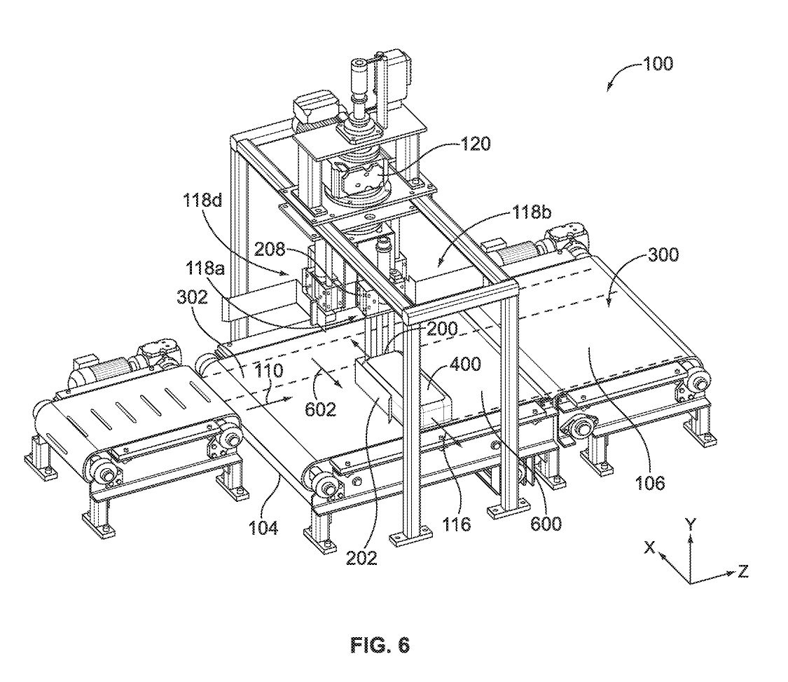

As shown in FIG. 6, the bag turning assembly 118A releases the second bag 400 when the bag turning assembly 118A has been rotated approximately ninety degrees by the rotation device 120. Rotation of the bag turning assembly 118A by approximately ninety degrees results in rotation of the second bag 400 by approximately ninety degrees. For example, the longitudinal axis 116 of the second bag 400 is oriented at an angle with respect to the feed direction 110 after rotation of the bag turning assembly 118A and the second bag 400. By way of example only, the longitudinal axis 116 of the rotated second bag 400 may be oriented approximately perpendicular to the feed direction 10.

In the illustrated embodiment, after rotation of the bag turning assembly 118A, the blocking and rotating paddles 200, 202 of the bag turning assembly 118A no longer block movement of the rotated second bag 400 in the feed direction 110 along the turner conveyor 104. For example, the approximately planar body of the blocking paddle 200 is oriented approximately parallel to the feed direction 110 and the rotating paddle 202 is positioned upstream of the rotated second bag 400. As a result, neither of the blocking and rotating paddles 200, 202 are positioned to restrict further movement of the rotated second bag 400 along the turner conveyor 104. The rotated second bag 400 may continue movement along the turner conveyor 104 in the feed direction 110 along a rotated path 600.

The rotated path 600 is the route over which the rotated second bag 400 travels along the turner conveyor 104 to the palletizing staging area 300 of the pick conveyor 106. As shown in FIG. 6, the rotated path 600 is laterally displaced with respect to the initial path 302. For example, the rotated path 600 may be located away from the initial path 302 in a lateral direction 602. In the illustrated embodiment, the lateral direction 602 is transverse to the feed direction 110. The rotated path 600 may be adjacent to, or separated from, the initial path 302. Rotation of the bag turning assembly 118A and the second bag 400 may result in the second bag 400 being moved laterally along the turner conveyor 104. For example, rotating the second bag 400 causes the second bag 400 to be moved from the initial path 302 to the laterally displaced rotated path 600. The second bag 400 is moved in the lateral direction 602 as the second bag 400 is rotated.

After rotating and releasing the second bag 400, the bag turning assembly 118A is raised by the lifting actuator 208 to the upper position before resuming rotation of the bag turning assemblies 118A-D. Alternatively, the rotation device 120 may resume rotation of the bag turning assemblies 118A-D before the bag turning assembly 118A is raised to the upper position. The bag feeding device 100 continues to lift one or more of the bag turning assemblies 118A-D away from the turner conveyor 104 to permit bags 108 to move toward the palletizing staging area 300 along the initial path 302 and to lower and rotate the bag turning assemblies 118A-D in order to rotate other bags 108 to the rotated path 600. In one embodiment, the bag feeding device 100 continually operates to permit a first set of the bags 108 to travel along the initial path 302 while blocking and rotating a second set of the bags 108 to travel along the rotated path 600.

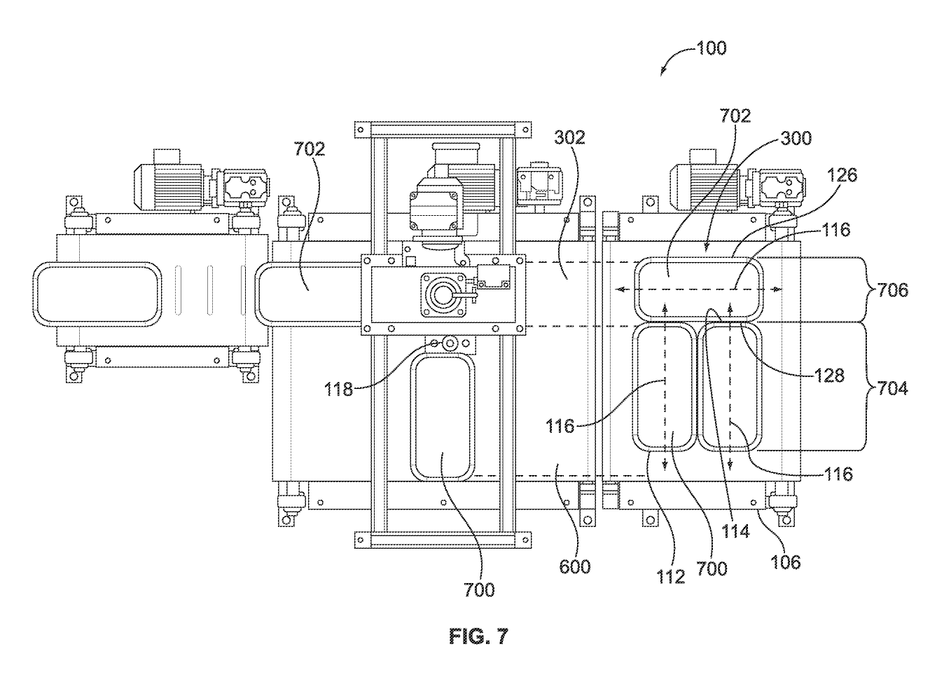

FIG. 7 is an overhead view of the bag feeding device 100 in accordance with one embodiment. The bag feeding device 100 may concurrently or simultaneously move and rotate a first bag 700 to the rotated path 600 while permitting a second bag 702 to pass underneath the bag turning assemblies 118 along the initial path 302. For example, one of the bag turning assemblies 118 that is aligned with the initial path 302 may be raised to the upper position to permit the second bag 702 to pass along the initial path 302 as another one of the bag turning assemblies 118 rotates the first bag 700 to the rotated path 600. The bag feeding device 100 may simultaneously or concurrently rotate the bags 700 while arranging the bags 700 and 702 in two rows 704, 706 in the palletizing staging area 300.

The bags 700, 702 are received and arranged in the palletizing staging area 300 in a predetermined pattern. In the illustrated embodiment, the rotated bags 700 and non-rotated bags 702 are arranged in the rows 704, 706. One row 704 includes the rotated bags 700 arranged proximate to one another with the longitudinal axes 116 of the rotated bags 700 being approximately parallel with one another. The other row 706 includes at least one non-rotated bag 702. Alternatively, the row 706 may include several non-rotated bags 702. The non-rotated bag 702 is positioned in the palletizing staging area 300 such that the longitudinal axis 116 of the non-rotated bag 702 is angled with respect to the longitudinal axes 116 of the rotated bags 700 in the row 704. In the illustrated embodiment, the longitudinal axis 116 of the non-rotated bag 702 is approximately transverse or perpendicular to the longitudinal axes 116 of the rotated bags 700.

The bags 700, 702 may be arranged in the palletizing staging area 300 such that one of the sides 126, 128 of the non-rotated bag 702 is disposed proximate to the ends 112 or 114 of a plurality of the rotated bags 704. For example, one side 128 of the non-rotated bag 702 may be adjacent to the ends 114 of at least two of the rotated bags 700. Alternatively, the side 128 of the non-rotated bag 702 may be separated from the ends 114 of the rotated bags 700 by a relatively small distance. The arrangement of the bags 700, 702 in the rows 704, 706 provides for a relatively densely packed arrangement of the bags 700, 702 and may increase the number of bags 700, 702 that fit into a given surface area on a pallet or volume in a storage unit.

In one embodiment, the bags 700, 702 are arranged in a single layer of bags 700, 702 in the palletizing staging area 300. For example, the bags 700, 702 are positioned into the rows 704, 706 in individual layers of the bags 700, 702 without any additional bags 700, 702 being placed on top of the bags 700, 702. The bags 700, 702 may be picked up by a robotic pick machine (not shown) from the palletizing staging area 300 or conveyed by the pick conveyor 106 to a pallet or other storage container (not shown). The bags 700, 702 may be moved from the pick conveyor 106 in the arrangement or patterns shown in FIG. 7.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first.” “second,” and “third,” etc. are used merely as labels, and are not intended to impose numerical requirements on their objects. Further, the limitations of the following claims are not written in means—plus-function format and are not intended to be interpreted based on 35 U.S.C. §112, sixth paragraph, unless and until such claim limitations expressly use the phrase “means for” followed by a statement of function void of further structure.

What is claimed is:

1. A bag feeding device for a palletizing system comprising:
a conveyor for moving bags to a palletizing staging area, each of the bags extending between opposite ends along a longitudinal axis;
bag turning assemblies disposed above the conveyor and configured to individually move toward and away from the conveyor independent of one another to engage and avoid engagement, respectively, with the bags as the bags move toward the palletizing staging area; and
a rotation device operatively coupled to the bag turning assembles and configured to rotate the bag turning assemblies and the bags engaged by the bag turning assemblies about a rotational axis, wherein the bag turning assemblies avoid engagement with at least one of the bags in a first set and engage and rotate at least one of the bags in a second set to arrange the bags in first and second rows, respectively, in the palletizing staging area.

2. The device of claim 1, wherein each of the bags extends between opposite sides along a lateral axis, further wherein the bag turning assemblies arrange the bags in the palletizing staging area such that at least one of the sides of each bags in the first row is located proximate to at least one of the ends of a plurality of bags in the second row.

3. The device of claim 1, wherein the bag turning assemblies each comprise a blocking paddle and a rotating paddle angled with respect to one another, the blocking paddle lowered toward the conveyor to block movement of each bag engaged by the bag turning assembly as the bag moves toward the palletizing staging area, the rotating paddle rotated toward the palletizing staging area to rotate the bag toward the palletizing staging area.

4. The device of claim 1, wherein the conveyor moves the bags along a feed direction, the bag turning assemblies rotating and moving each of the bags engaged by the bag turning assemblies in a lateral direction that is oriented transverse with respect to the feed direction.

5. The device of claim 1, wherein the bag turning assemblies are simultaneously rotated.

6. The device of claim 1, wherein the bags are arranged in the first and second rows in the palletizing staging area in each individual layer of bags.

7. The device of claim 1, wherein the bag turning assemblies engage and rotate the bags approximately ninety degrees.

8. The device of claim 1, wherein a first one of the bag turning assemblies engages and rotates one of the bags as a second one of the bag turning assemblies avoids engagement with a subsequent one of the bags.

9. A bag feeding device for a palletizing system comprising:
a conveyor for moving bags along a feed direction toward a palletizing staging area, each of the bags extending between opposite ends along a longitudinal axis;
a bag turning assembly configured to move toward and away from the conveyor to engage and avoid engagement, respectively, with the bags as the bags move toward the palletizing staging area, the bag turning assembly configured to rotate the bags engaged by the bag turning assembly; and
a rotating device operatively coupled with the bag turning assembly and configured to rotate the bag turning assembly about a rotation axis, wherein the bag turning assembly switches between avoiding engagement with the bags and engaging and rotating the bags as the bags move toward the palletizing staging area to arrange the bags in first and second rows in individual layers of bags, the longitudinal axis of the bag in the first row being angled with respect to the longitudinal axes of the bags in the second row.

10. The device of claim 9, wherein the system comprises a plurality of the bag turning assemblies disposed above the conveyor and configured to individually move toward and away from the conveyor independent of one another to engage and avoid engagement, respectively, with the bags as the bags move toward the palletizing staging area.

11. The device of claim 10, wherein the bag turning assemblies are simultaneously rotated.

12. The device of claim 10, wherein a first one of the bag turning assemblies engages and rotates one of the bags as a second one of the bag turning assemblies avoids engagement with a subsequent one of the bags.

13. The device of claim 9, wherein each of the bags extends between opposite sides along a lateral axis, further wherein the bag turning assembly arranges the bags in the palletizing staging area such that at least one of the sides of each bags in the first row is located proximate to at least one of the ends of a plurality of bags in the second row for each layer of bags.

14. The device of claim 9, wherein the bag turning assembly comprises a blocking paddle and a rotating paddle angled with respect to one another, the blocking paddle lowered toward the conveyor to block movement of each bag engaged by the bag turning assembly as the bag moves toward the palletizing staging area, the rotating paddle rotated toward the palletizing staging area to rotate the bag toward the palletizing staging area.

15. The device of claim 9, wherein the bag turning assembly rotates and moves each of the bags engaged by the bag turning assembly in a lateral direction that is oriented transverse with respect to the feed direction.

16. The device of claim 9, wherein the bag turning assembly engages and rotates the bags approximately ninety degrees.

17. A method for arranging bags travelling along a conveyor in a feed direction toward a palletizing staging area, the bags extending between opposite ends along a longitudinal axis, the method comprising:
providing a bag turning assembly that is configured to be raised and lowered toward the conveyor, the bag turning assembly raising away from the conveyor to avoid blocking movement of the bags in the feed direction, the bag turning assembly lowering toward the conveyor to block movement of the bags in the feed direction; and
providing a rotating device that is operatively coupled with the bag turning assembly and configured to rotate the bag turning assembly about a rotation axis, wherein the bag turning assembly and the rotating device are configured to raise the bag turning assembly and lower and rotate the bag turning assembly in a predefined sequence to arrange the bags in first and second rows in the palletizing staging area.

18. The method of claim 17, wherein providing the bag turning assembly comprises providing a plurality of the bag turning assemblies configured to be individually raised and lowered toward the conveyor independent of one another.

19. The method of claim 17, wherein providing the rotating device comprises operatively coupling the rotating device to the bag turning assembly such that rotation of the bag turning assembly rotates and laterally displaces the bag that is blocked by the bag turning assembly.

20. The method of claim 17, wherein the bags are arranged in the first and second rows in the palletizing staging area in each individual layer of bags.
